(19) United States
(12) Patent Application Publication
(10) Pub. No.: US 2026/0100109 A1
(43) Pub. Date: Apr. 9, 2026

(54) GAMING DEVICE FOR POKER GAME HAVING VARIABLE BONUS AWARDS

(71) Applicant: KING SHOW GAMES, INC., Minnetonka, MN (US)

(72) Inventor: Bradley BERMAN, Minnetonka, MN (US)

(21) Appl. No.: 19/350,415

(22) Filed: Oct. 6, 2025

Related U.S. Application Data
(60) Provisional application No. 63/704,025, filed on Oct. 6, 2024.

(51) Int. Cl. G07F 17/32

(52) U.S. Cl. CPC G07F 17/3293; G07F 17/3244

(57) ABSTRACT

Embodiments of the present invention set forth systems, apparatuses and methods for facilitating a poker game having additional award opportunities. Accordingly, a gaming device can be configured to include a display, a player interface, a memory device configured to store a paytable and a bonus award table having a plurality of variable bonus awards associated with respective ones of at least a portion of the pays included in the paytable, and a processor configured to deal a first poker hand and evaluate the first poker hand for awards. The processor is further configured to randomly determine whether to associate a bonus indicator with the first poker hand and if such a bonus indicator is so associated, to further randomly determine a bonus modifier from the bonus award table that is associated with first poker hand based on the where the first poker hand is evaluated in the paytable.

### RELATED APPLICATIONS

This application claims the benefit of Provisional Patent Application No. 63/704,025, filed on October 6, 2024, to which priority is claimed pursuant to 35 U.S.C. §119(e) and which is incorporated herein by reference in its entirety.

### FIELD OF THE INVENTION

This disclosure relates generally to games, and more particularly to systems, apparatuses and methods for providing poker games having variable bonus awards in gaming devices.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate a poker game having variable bonus awards.

According to one example embodiment, a gaming device can be configured to include a display, a player interface, a memory device configured to store a paytable and a bonus award table having a plurality of variable bonus awards associated with respective ones of at least a portion of the pays included in the paytable, and a processor configured to deal a first poker hand and evaluate the first poker hand for awards. The processor is further configured to randomly determine whether to associate a bonus indicator with the first poker hand and if such a bonus indicator is so associated, to further randomly determine a bonus modifier from the bonus award table that is associated with first poker hand based on the where the first poker hand is evaluated in the paytable.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a gaming machine according to embodiments of the invention.

FIG. 2 is a block diagram illustrating a computing arrangement according to embodiments of the invention.

FIG. 3A is a diagram of a display of a gaming device showing a poker game having additional award opportunities according to embodiments.

FIG. 3B is a diagram of a bonus award table associated with the gaming device display shown in FIG. 3A.

FIGS. 4A, 4B, and 4C are diagrams of various bonus award tables according to embodiments.

FIGS. 5A and 5B are diagrams of a display of a gaming device showing a poker game having variable bonus awards according to embodiments.

FIGS. 6A and 6B are diagrams of a display of a gaming device showing another poker game having variable bonus awards according to embodiments.

FIG. 7 is a flow diagram showing a method of operating a gaming device having a poker game with variable bonus awards according to embodiments.

FIG. 8 is a diagram of a display of a gaming device showing a multi-hand poker game having additional award opportunities according to embodiments.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for providing variable bonus awards in gaming activities. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. a video poker game) are provided for purposes of facilitating an understanding of the features described herein. However, the principles described herein are equally applicable to any game of chance where an outcome(s) is determined for use in the player’s gaming activity.

Embodiments of the present concept include providing gaming devices (also referred to as gaming apparatuses or gaming machines), gaming systems, and methods of operating these devices or systems to provide game play that provide poker games having variable bonus awards. In some embodiments, these variable bonus awards are each associated with a particular payout or award listed in a paytable used to evaluate a poker hand for awards. The variable bonus awards may be stored in a memory device of the gaming machine (or may be remotely stored on, for example, a game server) and include a plurality of award types or ranges of award values that may be randomly selected from when a particular award is indicated during the evaluation of the poker game and a random determination is made to provide a bonus award.

In some embodiments, players may place a bonus bet or side wager to be eligible for the variable bonus awards. However, in other embodiments, a single wager may be used with the pays in the one or more paytables being reduced to account for the game’s hold or amount of wagers not theoretically returned during play. In various embodiments, the poker hand may be a stud poker hand, draw poker hand, part of a multi-hand poker game, or other type of card hand that is evaluated using a paytable.

In some example embodiments, the variable bonus awards may be reflected in a predefined table that lists for each (or at least a portion of) award type in a poker paytable a plurality of possible bonus awards. These plurality of possible bonus awards may be variety of awards types, such as multipliers, bonus credits, free games, extra cards to add to the poker hand, multi-indicia cards, wild cards, replacement cards with faces or aces, etc. In other embodiments, the plurality of possible bonus awards may be ranges of particular bonus awards, such as ranges of multipliers to use to multiply evaluated awards from the poker hand, or ranges or bonus credits to add to any evaluated awards from the poker hand.

These inventive principles can also be applied to embodiments that use multiple hands, such as multi-play hands or multiple separate poker hands. Here, each poker hand may be separately evaluated and have a separate determination of whether to provide a bonus for that respective hand. For each hand where it is determined that a bonus condition is met, a bonus award table may be used to randomly determine what type and/or value of bonus award or modifier to provide for that respective poker hand.

By providing variable bonus awards, embodiments of the present invention may allow for a maximum award liability for operators of the gaming device, and/or may allow a highly varied bonus experience for players playing the poker game. For video poker machines that are configured to operate a poker game using embodiments of the present invention, the present inventive concept may improve the functionality of the specific video poker machines by improving the processing speed of a processor used to handle the game code by using a separate, predefined bonus award table to store the variable bonus awards associated with various entries in a paytable. Here, the processor needs only to reference the variable awards or award ranges associated with a particular evaluated poker hand rather than running through larger bonus award scenarios that don’t have applicability to the particular evaluated poker hand. This improved speed allows for smoother game play, improved graphic rendering, and less power use.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve video poker machine examples of this concept, other embodiments include application of these inventive techniques in other types of slot games, poker games, or other games of chance. Some of these other types of embodiments will be discussed below as variations to the examples illustrated. However, many other types of games can implement similar techniques and fall within the scope of this inventive concept.

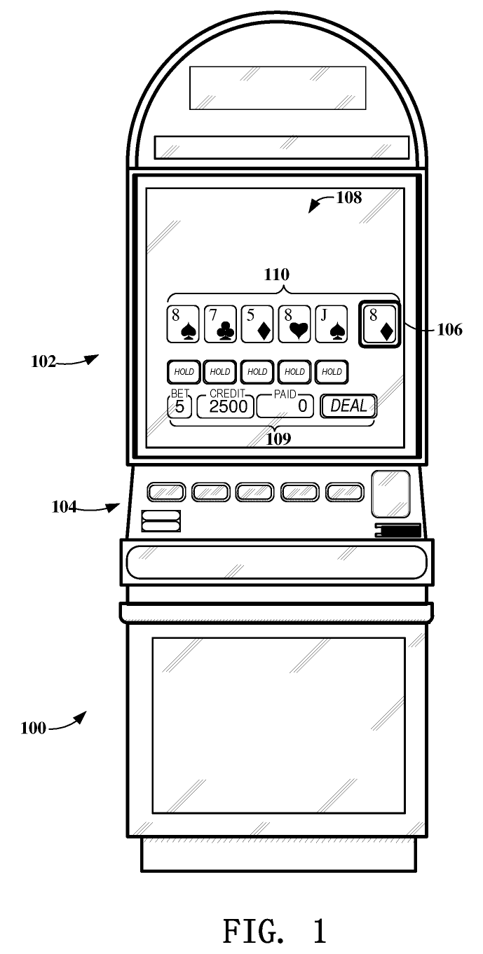

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. In some embodiments, the gaming apparatus may be video poker machine for use in a casino. The only purpose of this example video poker machine is to provide a secure device to host a video poker game and include specialized components to receive money, establish a credit value on the machine from which a player may place wagers, and provide a payout to the player when they cashout any remaining credits on the video poker machine. Additionally, the video poker machine may include specialized button panels and/or other specialized user interface devices to allow a player at the casino to play the poker game in the video poker machine.

The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

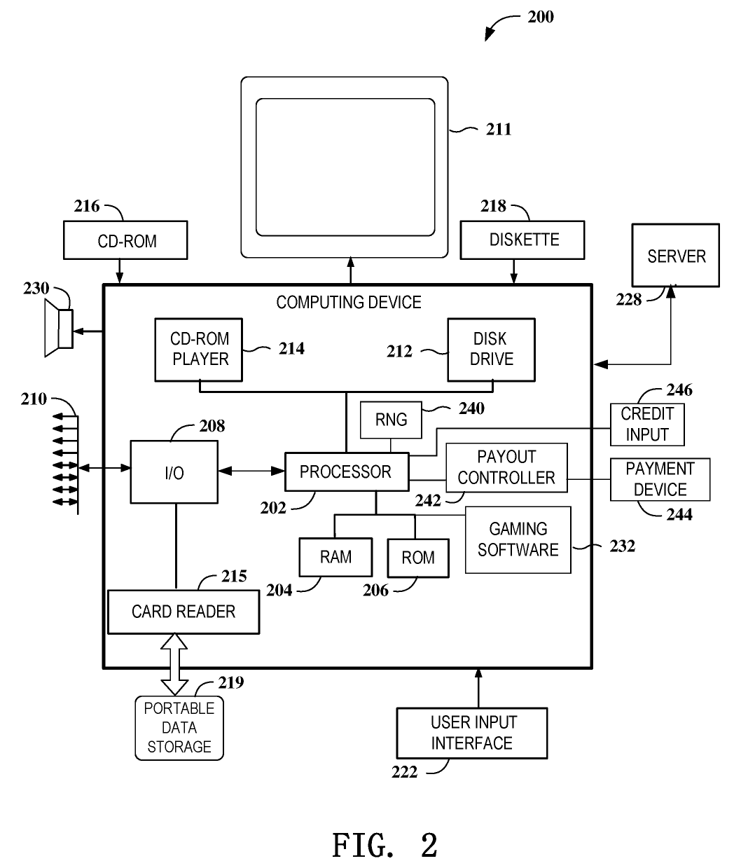

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player loyalty information to identify a user or player of the gaming device. This mechanism may be card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some the example embodiments illustrated herein, the primary gaming portion 108 may display a grid (or equivalent arrangement) of playing cards 110 forming a hand. Here, the grid includes a row of five playing cards 110 forming a video poker hand, which represents a portion of a game play event. For example, if the game play event is a video draw poker game, the gaming device 100 may deal five cards, allow the user to select which cards to hold, deal replacements for the cards not held, and determine a payout based on the final cards in the hand. Additionally, the grid of playing cards 110 may include a location for one or more additional cards to be displayed along with the primary (such as 5-card) poker hand to form a second poker hand. The illustration and description of five-card-draw poker is for purposes of example and not of limitation; the present invention may be applicable to numerous other card games, such as stud poker or hold ‘em poker, as well as other types of gaming activities and apparatuses, such as slot machines, dice, coins, etc.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual cards for holding prior to the draw of new cards. The game display 106 of the display area102 may include other features that are not shown, such as paytables, navigation controls, etc.

Although FIG. 1 illustrates a particular implementation of some of the embodiments of this invention in a casino or electronic gaming machine (“EGM”), one or more devices may be programmed to play various embodiments of the invention. The present invention may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the invention is illustrated in FIG. 2.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 200 of FIG. 2 is an example computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions in accordance with the present invention typically includes a central processor (CPU) 202 coupled to random access memory (RAM) 204 and some variation of read-only memory (ROM) 206. The ROM 206 may also represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to the display 211, which represents a display on which the gaming activities in accordance with the invention are presented. The display 211 represents the “presentation” of the game information in accordance with the invention, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. The present invention is operable using any known RNG, and may be integrally programmed as part of the processor 202 operation, or alternatively may be a separate RNG controller 240. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 indicating a payout is to be made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout device 244 may also be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described hereinabove. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 232 may include instructions to provide other functionality as known in the art or as described and shown herein.

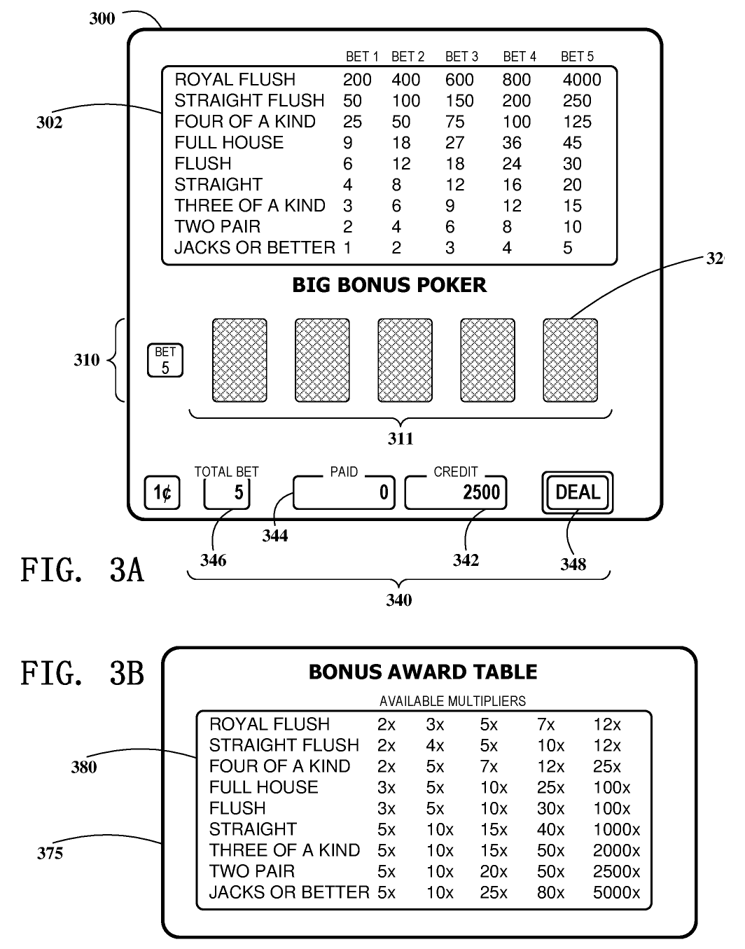

FIG. 3A is a diagram of a display of a gaming device showing a poker game having additional award opportunities according to embodiments. FIG. 3B is a diagram of a bonus award table associated with the gaming device display shown in FIG. 3A.

Referring to FIG. 3A, a gaming display 300 of a gaming device includes a poker paytable 302, a game play area 310 having a poker hand 311 of playing cards 320, and a player interface area 340 having a total bet meter 346, a paid meter 344, a credit meter 342, and a Deal/Draw button 348. Although this embodiment shows particular features, these features may be different in other embodiments.

Referring to FIG. 3B, a bonus award table 380 associated with the gaming device shown in FIG. 3A is shown stored in a memory device 375. The memory device 375 may be located in the same gaming device as the gaming display 300 shown in FIG. 3A, or may be stored remotely on a server (not shown) or other remote computing device. The bonus award table 380 shows various possible bonus awards for each of the poker outcomes associated with awards in the paytable 302. When a final poker hand 311 is displayed in the game play area 310, the final poker hand is evaluated for awards against the paytable 302. If the final poker hand 311 is associated with an award in the paytable 302, a random determination is made as to whether the poker game is bonused. This random determination may be shown, for example, by putting a subsymbol overlay on the 5^{th}card 320 (or any card) in the final poker hand 311. If such a random determination satisfied a predetermined condition, a bonus award (which in this embodiment is a bonus multiplier) is randomly chosen from the bonus award table 380 based on the type of outcome for the final poker hand 311. For example, if the final poker hand resulted in a flush, and a random determination resulted in a bonus modifier being awarded, a random determination would be made as to which of the available multipliers for flush wins (i.e., 3x, 5x, 10x, 30x, or 100x) is awarded. In some embodiments, each of the potential multiplier values have an equal chance of being awarded, while in other embodiments, each of the potential multiplier values associated with the flush outcome are weighted so that some of the outcomes (such as a 5x award) is more likely than other bonus outcomes (such as the 100x award).

Here, the bonus award table 380 can be constructed by game producers, or end user operators at, for example, a casino, to have a maximum liability (or top potential award) won for any given poker outcome. That is, the top award for a Royal Flush outcome only has a maximum bonus award multiplier of “12x” while an award for a high pair has a maximum bonus award multiplier of “5000x”. Thus, large multiplier awards may be available for poker hands associated with smaller award pays, while higher poker hand awards may be limited in the maximum bonus award multiplier.

Although a single poker hand is shown in FIGS. 3A and 3B, the same principle can be applied to embodiments with multiple poker hands (i.e., a multi-hand poker game), where the random determination of whether to associated a bonus award may be separately made for each of the poker hands in the multi-hand poker game, although in some embodiments, only a single random determination may be made for the multi-hand poker game as a whole (which may be applied to one, some, or all of the hands in the multiple poker hands.

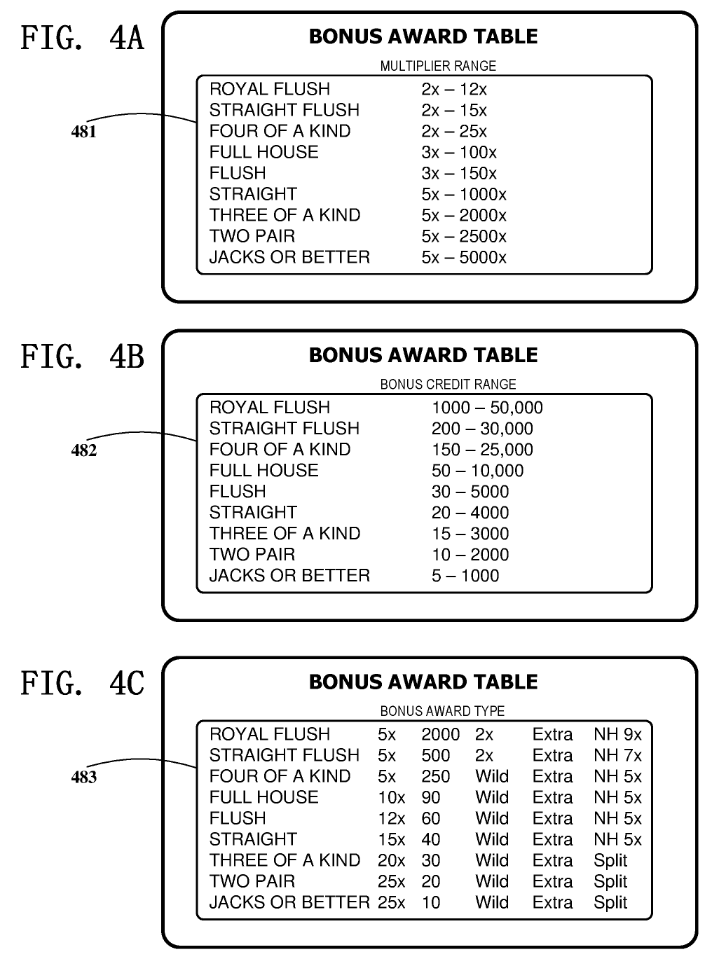

FIGS. 4A, 4B, and 4C are diagrams of various bonus award tables according to embodiments. As shown in these example bonus award tables 481, 182, 483, the possible awards associated with various poker hands (or game outcomes) can vary from ranges of multipliers (as shown in the bonus award table 481 of FIG. 4A), to ranges of bonus credit awards (as shown in the bonus award table 482 of FIG. 4B, which may or may not be multiplied by the number of coins bet on the poker game), to various types of bonus awards (as shown in the bonus award table 483 of FIG. 4C) which may include, for example, multipliers, credit awards, Wild Cards, Extra card or cards, multi-indicia (or split) cards, and/or bonus modifiers that may be applied to the poker hand in the current poker game, or may be saved and applied to a poker hand in the next poker game that is wagered on.

For the bonus multiplier range in bonus award table 481 or the bonus credit range in bonus award table 482, the random determination of the value within these ranges may be from a selection of each individual value within such range, or may be from a certain value format or type within such range. For example, in bonus award table 481, if a player receives a royal flush, each of the multiplier values between “2x” and “12x” may be available for selection while if the player receives a three of a kind, only award values that are a multiple of “5” may be available (i.e., “5x”, “10x”, “15x”, … , “1995x”, and “2000x”).

In bonus award table 483, a selection of “NH 9x” means that the player will get a “9x” multiplier to use on next hand. In some embodiments, this means the next hand that the player places a wager on. For example, in a single hand poker game an award of “NH 9x” would mean that the player would receive a “9x” multiplier on the next single hand poker game that the player places a wager on. In other examples where a multi-hand poker game is played, the player may received the “9x” multiplier on the next hand within the multi-hand poker game (e.g., the hand above it), or may, in other embodiments, receive a “9x” multiplier on a corresponding poker hand on the next multi-hand poker game that the player places a wager on. In yet other embodiments, a “NH 9x” award may provide a “9x” multiplier on the current hand and the next poker game that the player places a wager on.

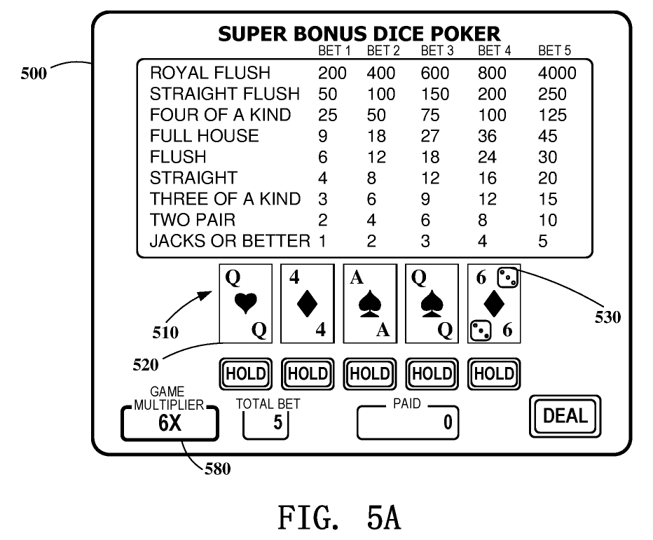

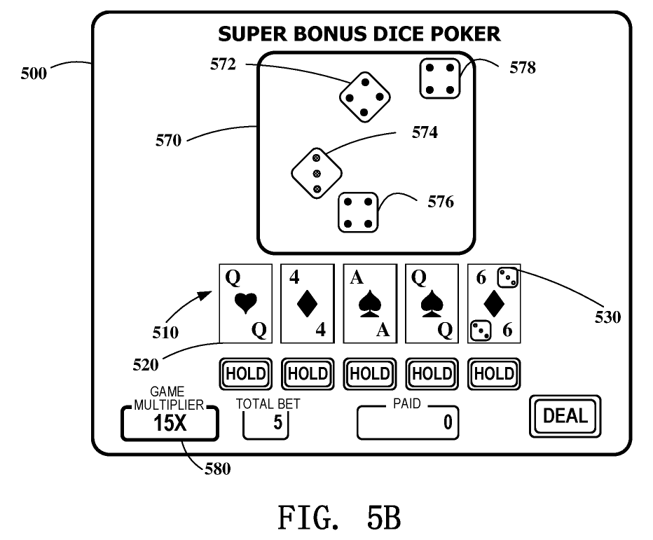

FIGS. 5A and 5B are diagrams of a display of a gaming device showing a poker game having variable bonus awards according to embodiments. More particularly, FIGS. 5A and 5B show an example embodiment of a variable bonus award opportunity where lower poker hands (such as a high pair) can randomly win between 2 and 6 bonus dice to give a bonus multiplier, while higher poker hands (such as a royal flush) can only randomly win between 1 and 2 dice to give a bonus multiplier.

Referring to FIG. 5A, a gaming display 500 of a gaming device includes a poker paytable, a game play area 510 having a poker hand of playing cards 520, and a player interface area having a total bet meter, a paid meter, a credit meter, a Deal/Draw button, and a bonus award meter 580. Although this embodiment shows particular features, these features may be different in other embodiments. Here, a poker game has been initiated and a bonus subsymbol overlay 530 randomly appears on the one of the virtual playing cards in the poker hand.

Referring to FIG. 5B, once the bonus subsymbol overlay 530 is received, a bonus window 570 is opened and a bonus feature is initiated. In this embodiment, as the player’s hand has resulted in a high pair, a random determination of 2 to 6 bonus dice is made. In this embodiment, the random determination resulted in 4 dice 572, 574, 576, 578 being available in the bonus feature. Here the dice 572, 574, 576, 578 are randomly rolled and the sum of each resulting sides of the dice is shown in the bonus award meter 580, which in this case results in a bonus multiplier of “15x”. A bonus award table (not shown here, but similar to 380 in FIG. 3B) may be stored in a memory device associated with the gaming device shown in FIG. 5A. The memory device may be located in the same gaming device as the gaming display 500, or may be stored remotely on a server (not shown) or other remote computing device.

Although a single poker hand is shown in FIGS. 5A and 5B, the same principle can be applied to embodiments with multiple poker hands (i.e., a multi-hand poker game), where the random determination of whether to associated a bonus award may be separately made for each of the poker hands in the multi-hand poker game, although in some embodiments, only a single random determination may be made for the multi-hand poker game as a whole (which may be applied to one, some, or all of the hands in the multiple poker hands.

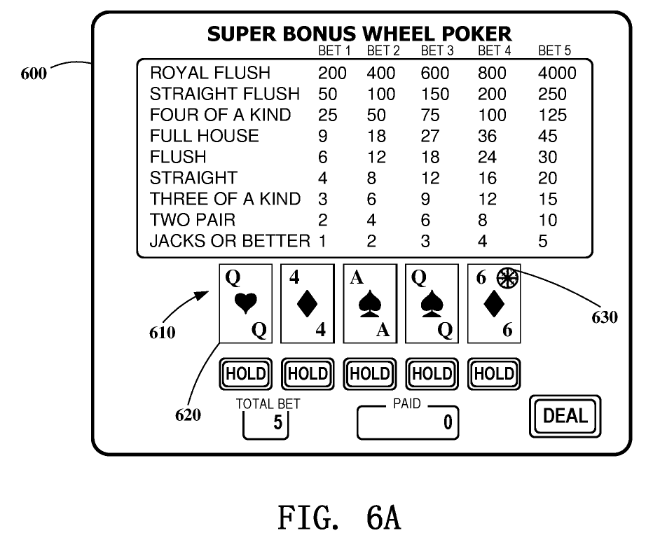

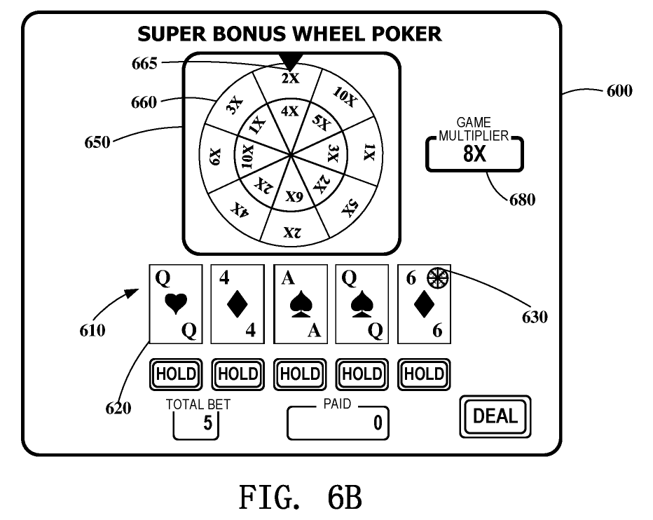

FIGS. 6A and 6B are diagrams of a display of a gaming device showing another poker game having variable bonus awards according to embodiments. More particularly, the embodiments shown in FIGS. 6A and 6B illustrates a different type of bonus game to award various bonus awards for a variable bonus award table. Here, lower poker hands (such as a high pair) can randomly win between 2 and 6 concentric wheels (or higher multiplier values on 2 concentric wheels) to give a bonus multiplier, while higher poker hands (such as a royal flush) can only randomly win between 1 and 2 concentric wheels (or lower multiplier values on 2 concentric wheels) to give a bonus multiplier.

Referring to FIG. 6A, a gaming display 600 of a gaming device includes a poker paytable, a game play area 610 having a poker hand of playing cards 620, and a player interface area having a total bet meter, a paid meter, a credit meter, and a Deal/Draw button. Although this embodiment shows particular features, these features may be different in other embodiments. Here, a poker game has been initiated and a bonus subsymbol overlay 630 randomly appears on the one of the virtual playing cards in the poker hand.

Referring to FIG. 6B, once the bonus subsymbol overlay 630 is received, a bonus window 650 is opened and a bonus feature is initiated. In this embodiment, as the player’s hand has resulted in a high pair, a random determination of 2 to 6 concentric bonus wheels is made. In this embodiment, the random determination resulted in 2 concentric bonus wheels 660 being available in the bonus feature. Here the two concentric bonus wheels 660 are spun and the sections of the bonus wheels that line up with a win indicator 665 are multiplied together and shown in a bonus award meter 680, which in this case results in a bonus multiplier of “8x”. A bonus award table (not shown here, but similar to 380 in FIG. 3B) may be stored in a memory device associated with the gaming device shown in FIG. 6A. The memory device may be located in the same gaming device as the gaming display 600, or may be stored remotely on a server (not shown) or other remote computing device.

Although a single poker hand is shown in FIGS. 6A and 6B, the same principle can be applied to embodiments with multiple poker hands (i.e., a multi-hand poker game), where the random determination of whether to associated a bonus award may be separately made for each of the poker hands in the multi-hand poker game, although in some embodiments, only a single random determination may be made for the multi-hand poker game as a whole (which may be applied to one, some, or all of the hands in the multiple poker hands.

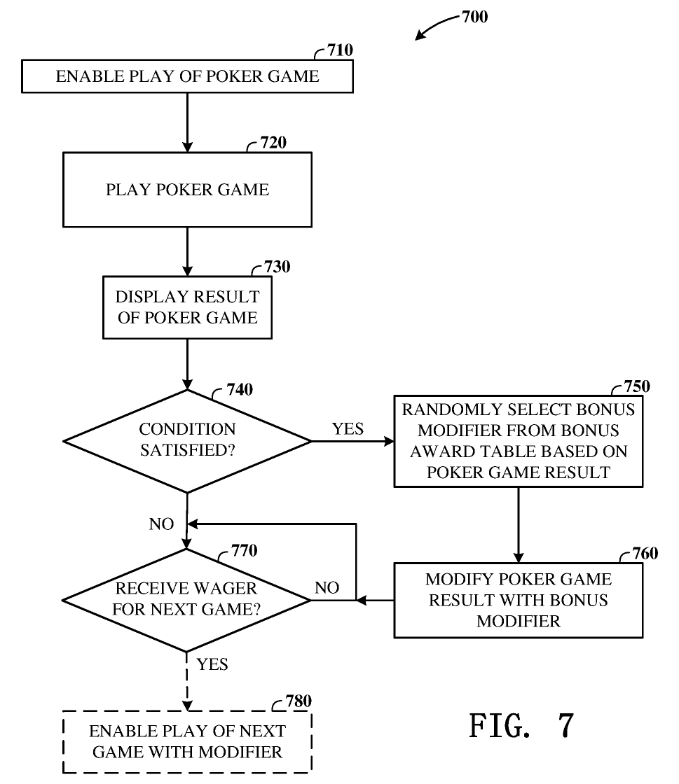

FIG. 7 is a flow diagram representing methods in which a gaming device and/or gaming system can be operated according to embodiments of the invention. Although various processes are shown in a particular order in this flow diagram, the order of these processes can be changed in other embodiments without deviating from the scope or spirit of this concept. Hence, the order of the processes shown is for illustrative purposes only and is not meant to be restrictive. Additional game processes may also be included between various processes even though they are not shown in this flow diagram for clarity purposes. Further each of the processes may be performed by components in a single game device, such as by a game processor, or may be performed in part or whole by a remote server or processor connected to the gaming device via a network. Each process may be encoded in instructions that are stored in a memory, a computer-readable medium, or another type of storage device. Note that these example methods are just some embodiments of how the steps of a game operation can be implemented. As discussed, and shown above, many variations exist which may require additional, fewer, or different processes to complete.

Referring to FIG. 7, an operation flow 700 of gaming device may being at process 710 where a first poker game is wagered on and initiated. In process 720, the poker game is presented to the player and played. The poker game may be a stud poker game or draw poker game. The poker game may only include a single hand of poker as part of the game, or may include multiple poker hands played in the same game (i.e., a multi-hand poker game). In process 730 the result of the played poker game is shown on the display. In process 740, it is determined whether bonus condition is satisfied. As discussed herein, a bonus condition may be satisfied or triggered based on a variety of criteria in different embodiments. For example, the bonus condition may be triggered based on a random determination seeded by a random number generator. Alternatively, the bonus condition may be triggered based on a virtual card being dealt (or drawn) to a poker hand with a subsymbol. In yet other embodiments, the bonus condition may be satisfied based on an evaluation of the dealt poker hand or final poker hand. As alluded to above, many other possible criteria may be used in different embodiments to determine if the bonus condition has been satisfied or triggered.

If a bonus condition has not been satisfied in process 740, the current poker game ends and flow 700 proceeds to process 770 to determine if a wager has been received for the next poker game. If, on the other hand, a bonus condition was satisfied in process 740, flow 700 proceeds to process 750 where bonus modifier is randomly selected from a bonus award table based on the poker game result that was displayed in process 730. Here, as described above, the bonus award table may have various ranges of modifiers or categories of modifiers to be randomly chosen from where the various ranges or categories of modifiers may be available based on the result of the poker game.

Flow 700 then proceeds to process 760 where the result of the current poker game is modified with the bonus modifier determined in process 750. Thereafter, the current poker game ends, and flow 700 proceeds to process 770 to determine if a wager has been received for the next poker game. In some embodiments, option process 780 may be part of the flow 700 whereby once a next poker game is wagered on and initiated in process 770, the modifier determined in process 750 is applied to one or more of the poker hands in the next poker game. In some embodiments, this option process 780 may be used in addition to process 760 where the modifier is applied to the first poker game (i.e., the modifier is used on the first poker game, the second or next poker game, and potentially one or more additional poker games). Alternatively in other embodiments, optional process 780 may supersede or replace process 760 whereby the modifier determined in process 750 is not applied to the first poker game, but is instead only applied to the second or next poker game (and potentially additional future poker games).

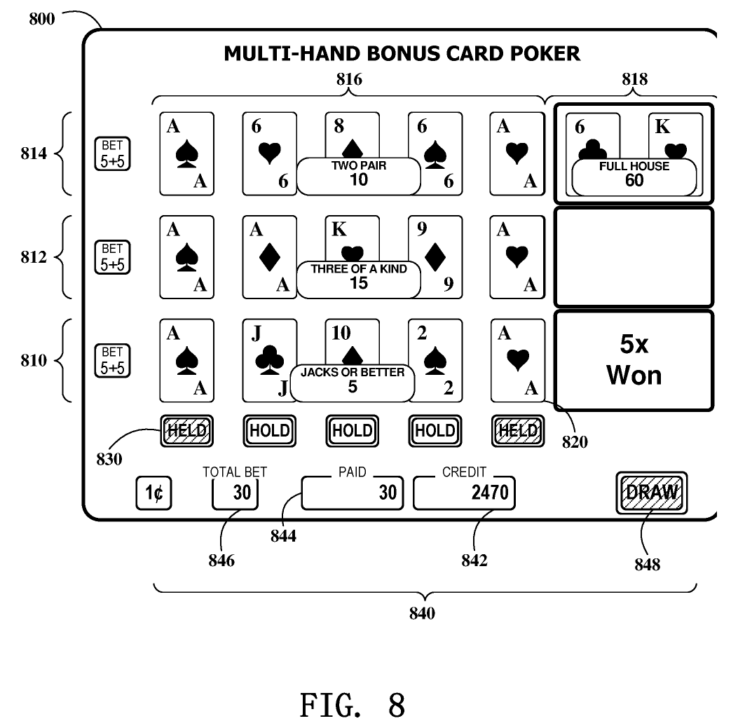

FIG. 8 is a diagram of a display of a gaming device showing a multi-hand poker game having additional award opportunities according to embodiments.

Referring to FIG. 8, a gaming display 800 of a gaming device includes a poker paytable, a game play area 816 having a first poker hand 810, a second poker hand 812, and third poker hand 814, each configured to have five card positions where virtual playing cards 820 can be dealt. Additionally, the gaming display 800 includes a bonus award area 818 that is configured to show bonus awards applied to each of the three poker hands 810, 812, 814 respectively. The gaming display 800 further includes a player interface area 840 having a total bet meter 846, a paid meter 844, a credit meter 842, and a Deal/Draw button 848. Although this embodiment shows particular features (such as three poker hands in the multi-hand poker game), these features may be different in other embodiments (such as having five, ten, fifty, or a hundred poker hands in the multi-hand poker game).

Here a bonus award table (not shown, but similar to 380 in FIG. 3B) may be associated with the gaming device having the game display 800 shown in FIG. 8. The bonus award table may be stored in a memory device (such as 375 in FIG. 3B) where the memory device may be located in the same gaming device as the gaming display 800 shown in FIG. 8, or may be stored remotely on a server (not shown) or other remote computing device. The bonus award table may provide different possible bonus ranges or categories depending on the result of the poker hand. For example, in the embodiment shown in FIG. 8 a poker game results in the first poker hand 810 resulting in a high pair, the second poker hand 812 resulting in a three of a kind, and the third poker hand 814 resulting in two pair. A random determination may be made for each poker hand 810, 812, 814 whether a bonus modifier should be award for each hand as they are all winning hands. Here, when a random determination is made to award a bonus modifier and the result of the poker hand is a high pair (such as with the first poker hand 810), another random determination is made to select a multiplier between “2x” and “25x”. When a random determination is made to award a bonus modifier and the result of the poker hand is two pair (such as with the third poker hand 814), another random determination is made to determine if one additional card should be dealt or two additional cards are to be dealt to the poker hand. Additionally, when a random determination is made to award a bonus modifier and the result of the poker hand is three of a kind (such as with the second poker hand 812), another random determination is made to select a multiplier between “2x” and “15x”. The bonus table may include additional bonus modifier ranges or categories for other poker hand results.

In the embodiment shown in FIG. 8 random determinations were made to award modifiers for the first poker hand 810 and third poker hand 814, but not the second poker hand 812. Thereafter a bonus multiplier was randomly selected from the range of multipliers associated with a high pair poker hand, which in this case resulted in a “5x” bonus award which was shown in the bonus award area 818 associated with the first poker hand 810. Simiarly, a number of additional cards was randomly selected from the range of additional cards associated with a two pair poker hand, which in this case resulted in two additional cards being awarded and dealt out in the bonus award area 818 associated with the third poker hand 814. Here, the full seven cards may then be evaluated for the best 5 card poker hand or against a 7 cards poker paytable.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

The principles described herein may be applied to other games, such as keno, bingo, etc. For example, in the context of keno, particular number positions (whether associated with positions of the player’s identified numbers or not) may be randomly identified with a sub-symbol or otherwise. When the triggering event occurs, one or more of the player’s keno numbers may be converted to Wild functionality so that any of the randomly selected keno balls serve as a matching number. Alternatively or additionally, multipliers or other modifiers may be provided analogously. Similar examples apply to games such as bingo, where a bingo card position may be marked as wild, and the current and/or subsequent bingo games treat the marked position as a free space (similar to the middle position in many bingo games) These and other applications of the enhancement features described herein may be employed.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out herein.

1. A video poker gaming apparatus comprising:
a video display device including a grid of card positions used to hold a poker hand;
a player interface including at least one button, the button configured to generate a signal in response to being activated;
a wager input device structured to receive physical items representing a currency amount;
a memory storing a credit amount, at least one deck of virtual playing cards, a poker paytable, and a bonus award table; and
a processor configured to:
receive a signal from the wager input device indicating receipt of a physical item representing currency;
increase the credit amount stored in memory based on the currency amount associated with the received physical item;
receive a wager on a first poker game, where an amount of the wager is deducted from the credit amount stored in the memory;
randomly deal a plurality of virtual playing cards from the deck of virtual playing cards stored in the memory to the grid of cards positions on the video display to form a first poker hand;
randomly determine whether to associate a bonus indicator with the first poker hand;
evaluate the first poker hand using the poker paytable stored in the memory to determine if the first poker hand is associated with an award and what type of poker hand is reflected by the result of the first poker hand;
if the bonus indicator is associated with the first poker hand:
determine which category of bonus modifiers is available from the bonus award table stored in the memory based on the evaluated result of the first poker hand;
randomly determine a bonus modifier from the determined category of bonus modifiers to award as an awarded bonus modifier; and
apply the awarded bonus modifier to the first poker hand; and
increase the credit amount stored in the memory based on any awards identified by the evaluation of the first poker hand as modified by the awarded bonus modifier.

2. The video poker gaming apparatus of claim 1, wherein the bonus award table includes ranges of multiplier values associated with different poker hand results.

3. The video poker gaming apparatus of claim 2, wherein the ranges of multiplier values in the bonus award table decrease in value as the award values from the poker paytable increase for respective ones of the different poker hand results.
